(19) United States
(12) Patent Application Publication
(10) Pub. No.: US 2007/0018954 A1
(43) Pub. Date: Jan. 25, 2007

(54) Control panel assembly for laundry machine

(76) Inventors: Han Ki Cho, Gimhae-si (KR); Jong Sung Yoon, Jinju-si (KR); Ho Sung Jang, Hadong-gun (KR); Chang Woo Son, Gimhae-si (KR); Jae Cheol Lyu, Changwon-si (KR)

Correspondence Address: FLESHNER & KIM, LLP, P.O. BOX 221200, CHANTILLY, VA, 20153, US

(21) Appl. No.: 11/476,938

(22) Filed: Jun. 29, 2006

(30) Foreign Application Priority Data
Jun. 30, 2005 (KR) 10-2005-0058010

(51) Int. Cl. G09G 5/00

(52) U.S. Cl. 345/156

(57) ABSTRACT

A control panel assembly for a laundry machine is disclosed. According to the present invention, a control panel assembly for a laundry machine which has a control panel cover for defining an exterior thereof, a PCB having various electric sub-assemblies mounted thereon and a display part, wherein the display part is a transparent window having at least one hole formed thereon and a button is provided trough the hole of the transparent window for allowing a user to operate outside. An object of the present invention is to provide a control panel assembly for a laundry machine having a conveniently direct structure for a user's operation.

This application claims the benefit of the Patent Korean Application No. 10-2005-0058010, filed on Jun. 30, 2005, which are hereby incorporated by reference as if fully set forth herein.

### BACKGROUND OF THE INVENTION

1. Field of the Invention

The present invention relates to a laundry machine, more particularly, to a control panel assembly for a laundry machine.

2. Discussion of the Related Art

In general, a drum type washing machine performs washing by using friction force between a drum rotated by a motor and laundry, in a state where wash water, detergent and the laundry are mixedly loaded into a drum. Thus, the drum type washing machine has an effect that the laundry may not be damaged, nor get entangled, and that the laundry may be washed as if it were scrubbed by human hands.

FIG. 1 is a perspective view illustrating an embodiment of a conventional drum type washing machine. A body 1 is provided in an approximately rectangular-parallelepiped shape, and a door 2 is coupled to a front surface of the body 1 for loading/unloading the laundry there through.

Also, a control panel 30 is provided in an upper portion of the front surface of the body 1 and includes plural buttons 34, a rotary knob 36 and a display window 32 made of glass or plastic having dark color.

Each button 34 and the rotary knob 36 are an inputting unit for operating the washing machine. When a user selects a washing time/a washing kind and a spinning/drying kind, he/she operates the buttons 34 and the rotary knob 36 and inputs the washing course or the washing time the user wants.

A display element 60 is provided in rear of the display window 32 to allow the user to be informed of various kinds of washing information such as a washing process condition and the remaining time through letters or symbols.

As shown in FIG. 2, the display window 32 includes an opening 42 formed in a side of the control panel cover 40 for defining an exterior of the control panel 30, a display element 60 provided in rear of the opening 42 and mounted in a PCB (not shown) of the control panel 30, and a transparent window 50 made of transparent material for shielding the opening 42.

As shown in FIG. 3, plural buttons 34 which are a kind of the inputting unit are provided in a lower portion of the transparent window 50. Also, an LED (Light Emitting Diode) lamp 35 is provided between the transparent window 50 and the button 34.

However, the structure of the conventional control panel assembly for a laundry machine has a problem of inconvenience that user interface deteriorates, because the display window 32 and the buttons 34 are spaced apart in a predetermined distance and the user should operate the buttons 34 as the user is turning away his/her eyes to see the display window 32.

### SUMMARY OF THE INVENTION

Accordingly, the present invention is directed to a control panel assembly for a laundry machine.

An object of the present invention is to provide a control panel assembly for a laundry machine having a conveniently direct structure for a user's operation.

Additional advantages, objects, and features of the invention will be set forth in part in the description which follows and in part will become apparent to those having ordinary skill in the art upon examination of the following or may be learned from practice of the invention.

The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a control panel assembly for a laundry machine which has a control panel cover for defining an exterior thereof, a PCB having various electric sub-assemblies mounted thereon and a display part, wherein the display part is a transparent window having at least one hole formed thereon and a button is provided trough the hole of the transparent window for allowing a user to operate outside.

Here, the button includes an elastic rib having elasticity; and a projecting part provided in a first end of the elastic rib, the projecting part projected outside through the hole of the transparent window.

The button further comprises a fixing part provided in a second end of the elastic rib for fixing the button to the control panel.

Furthermore, a hook part is provided in the control panel cover for fixing the fixing part of the button.

A hook part is provided in a rear surface of the transparent window for securing the fixing part of the button.

A pair of hooks may be spaced apart in a predetermined distance each other and the fixing part of the button may be inserted between the pair of hooks.

A pair of hooks may be spaced apart in a predetermined distance each other and the fixing part may be inserted between the pair of hooks.

A cut part may be formed in a portion of the elastic rib of the button for allowing the elastic rib bent smoothly.

Preferably, the cut part is formed in a portion of the elastic rib toward the fixing part.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view schematically illustrating an exterior of a conventional drum type washing machine according to the related art.

FIG. 2 is an exploded perspective view illustrating a display window of a control panel of FIG. 1.

FIG. 3 is a front view illustrating each exterior of the display window and an inputting part of the control panel of FIG. 1.

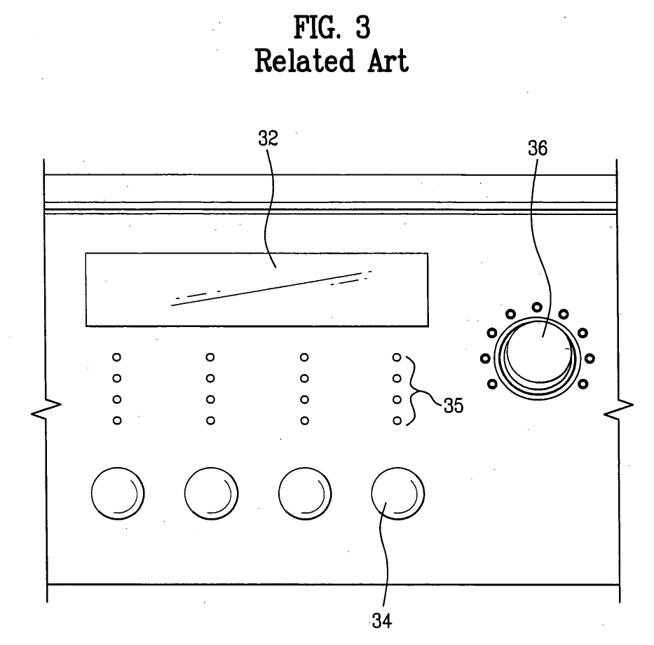

FIG. 4 is a rear perspective view illustrating a control panel cover and a transparent window according to an embodiment of a button assemble of a control panel of the present invention.

FIG. 5 is a perspective view illustrating a hook part according to the embodiment of the button of the control panel of the present invention.

FIG. 6 is a rear perspective view illustrating that the hook part of FIGS. 4 and 5 is fastened to the control panel cover.

FIG. 7 is a front view illustrating the embodiment of the button of the control panel of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

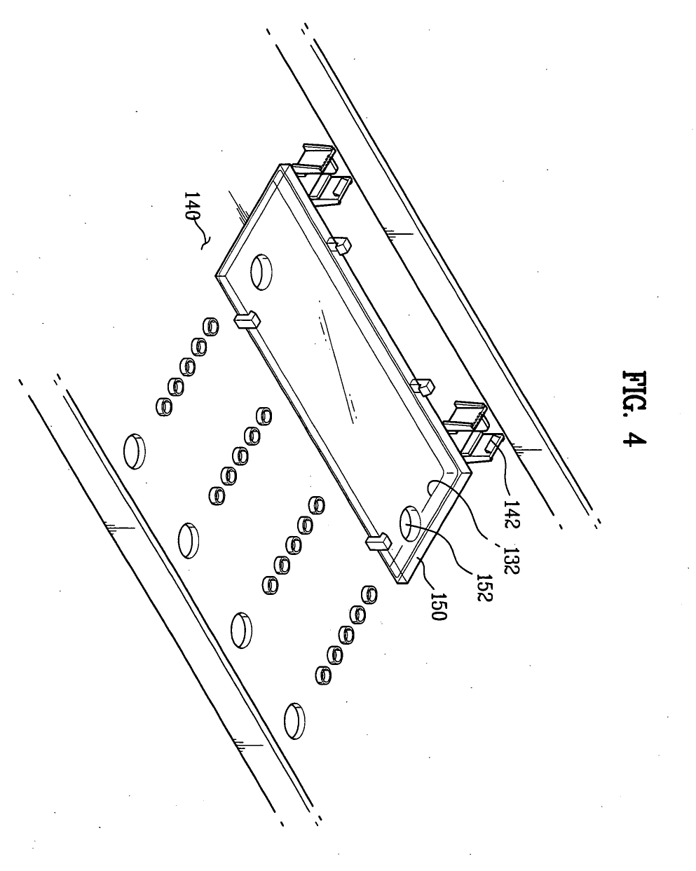

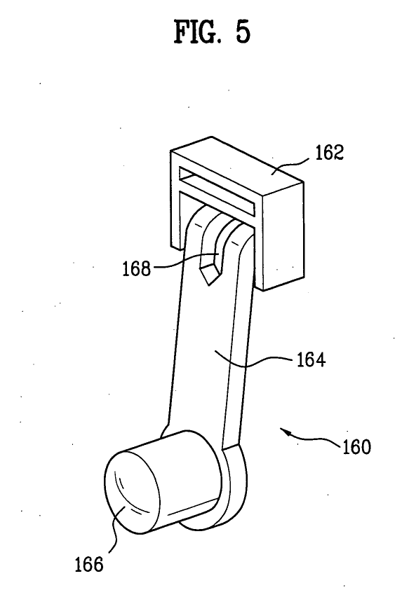

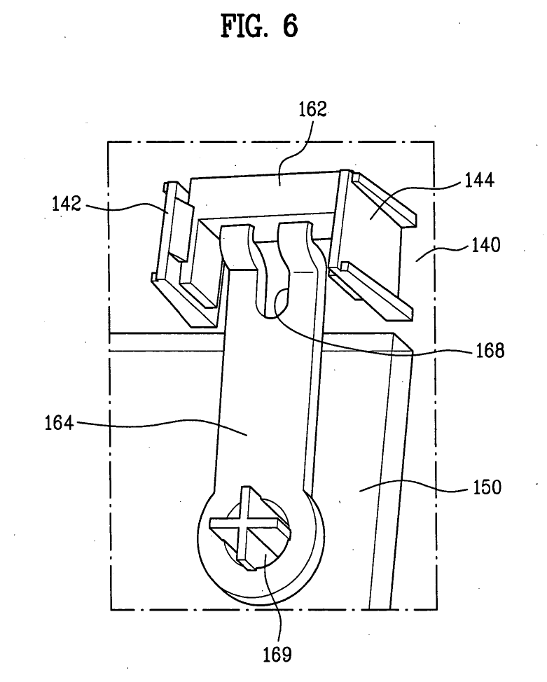

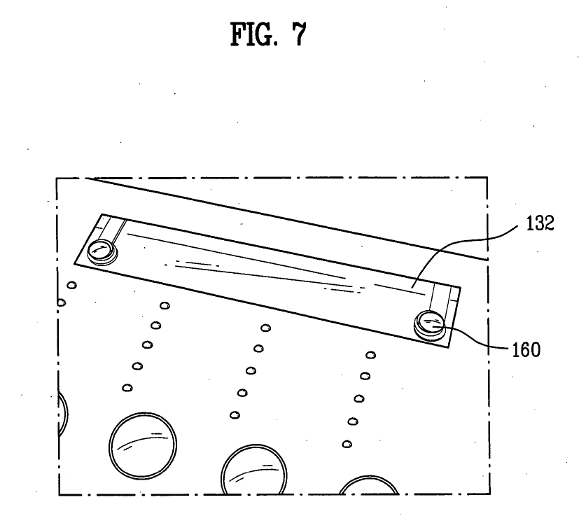

FIGS. 4 to 7 illustrate an embodiment of a button according to the present invention. FIG. 4 is a rear perspective view illustrating a control panel cover and a transparent window according to an embodiment of a button assemble of a control panel of the present invention. FIG. 5 is a perspective view illustrating a hook part according to the embodiment of the button of the control panel of the present invention. FIG. 6 is a rear perspective view illustrating that the hook part of FIGS. 4 and 5 is fastened to the control panel cover. FIG. 7 is a front view illustrating the embodiment of the button of the control panel of the present invention.

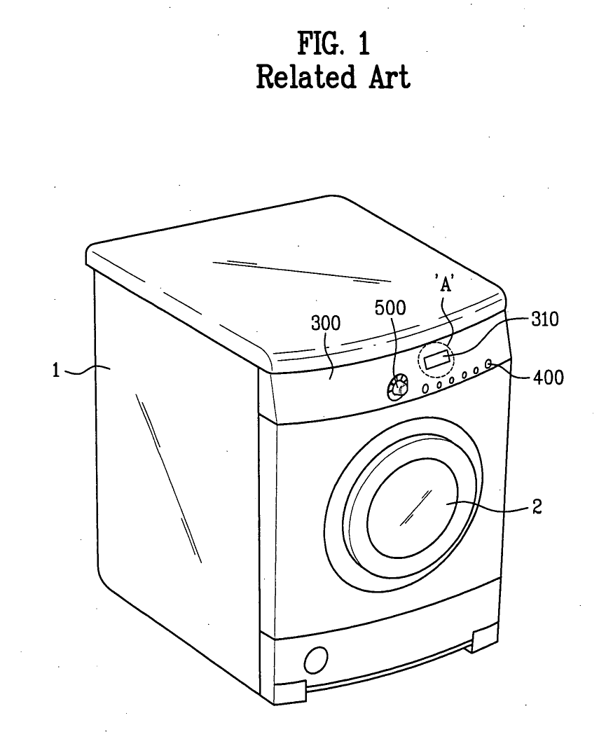

First of all, a control panel 30 (see FIG. 1) is provided in a side of a body, and has a display window 132 for allowing a user to be informed of a washing condition and an inputting unit for controlling operations of washing machine installed therein.

The control panel 30 includes a control panel cover 140 for defining an exterior thereof and a PCB (not shown) having various electric sub-assemblies (hereinafter, ESA) and switches (not shown) mounted thereon.

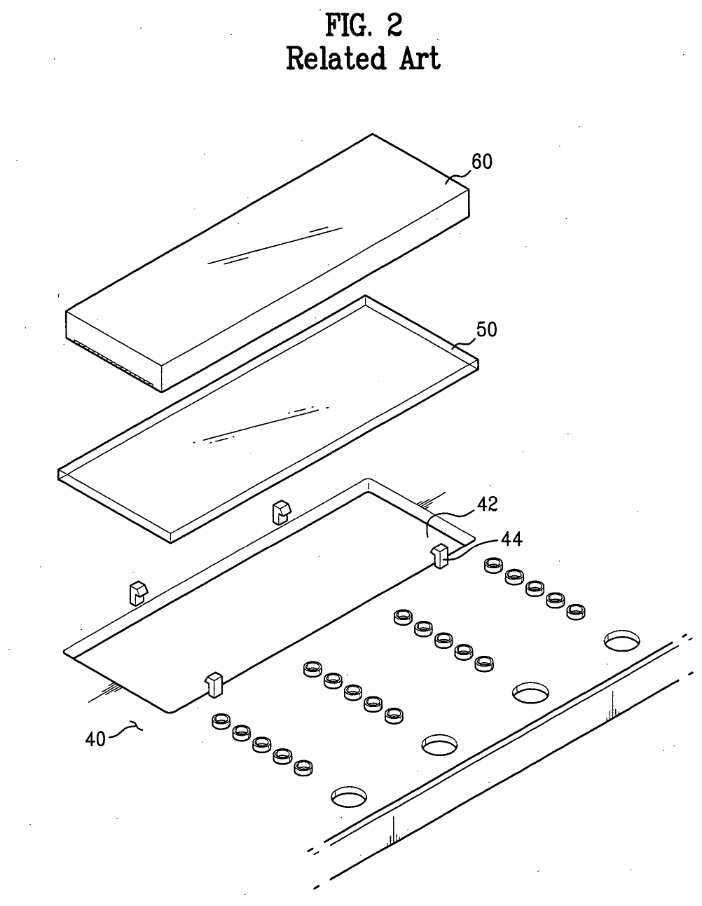

A display window 132 is provided in a side of the control panel cover 140 for displaying conditions of the washing machine outside. The display window 132 includes an opening (42: see FIG. 2) formed in a side of the control panel cover 140 and a display element (60: see FIG. 2) for displaying operation conditions of the washing machine through the opening 42.

That is, the control panel cover 140 having the opening 42 formed therein for defining an exterior thereof is provided, and the PCB (not shown) of the control panel 30 having the various ESA mounted thereon is provided in rear of the control panel cover 140. Also, the display element 60 is mounted in the opening 42 of the control panel cover 140 of the PCB (not shown).

As shown in FIG. 4, a transparent window 150 is provided between the control panel cover 140 and the display element 60 for shielding the opening 42.

Preferably, the transparent window 150 is made of transparent material so that the light generated by the display element 60 may transmit there through.

That is, the transparent window 150 shields the opening 42 to protect the display element 60, and transmits the light generated by the display element 60 outside.

Also, at least one hole 152 is formed in the transparent window 150.

Preferably, the hole 152 is formed in a lateral portion of the transparent window 150 not to interfere a screen area displayed in the hole 152.

According to the embodiment of the present invention, it is embodied that a hole 152 is formed in the opposite lateral portions of the transparent window 150, respectively. However, the present invention is not limited to the above embodiment.

A button 160 is provided in the control panel 30, and the button 160 is projected outside through the hole 152 of the transparent window 150.

As shown in FIG. 5, the button 160 includes a fixing part 162 fixed on a portion of the control panel 30, an elastic rib 164 expanded to a side from the fixing part 162, and a projecting part 166 formed in an end of the elastic rib 164 and inserted in the hole 152 of the transparent window 150.
Although not shown in drawings, a switch (not shown) is mounted on the PCB (not shown) corresponding to a rear surface of the projecting part 166.

Here, the fixing part 162 may be formed in a “ [symbol] ” shape. However, it is not limited thereto and may be varied in free shapes.

The elastic rib 164 is expanded from a side of the fixing part 162. The elastic rib 164 elastically supports the projecting part 166 so that the projecting part 166 may elastically move based on the user's pushing.

The elastic rib 164 may further include a cut part 168 cut in a portion thereof in a predetermined width so that the elastic rib 164 may bent by the user's pushing more smoothly. Since the elastic rib 164 has a cut portion with a predetermined width formed thereon, the section of the cut part 168 is lessened. Thus, although small power is applied to the elastic rib 164, the elastic rib 164 is bent smoothly.

The projecting part 166 is formed on an end of the elastic rib 164 for being inserted in the hole 152 of the transparent window 150.

The projecting part 166 is projected through the hole 152 of the transparent window 150, such that the user may push the projecting part 166 by using his/her hand.

As shown in FIG. 6, a protrusion 169 may be formed in a rear surface of the projecting part 166 for the switch (not shown) mounted in the PCB (not shown) to be pressed by the user's pushing more precisely.

That is, the fixing part 162 is secured to a side of the control panel 30 (see FIG. 1), and the projecting part 166 is inserted in the hole 152 and projected outside.

According to the embodiment, a hook part 142 is provided in the control panel assembly for fixing the button 160.

As shown in FIG. 6, the hook part 142 is fastened to the fixing part 162 to fix the button 160.

Preferably, the hook part 142 is formed in one of a rear surface of the control panel cover 140, a rear surface of the PCB (not shown) and a rear surface of the transparent window 150.

According to the present embodiment, the hook part 142 is formed in the rear surface of the control panel cover 140 so that the fixing part 162 is fixed to the control panel cover 140. However, it is not limited thereto.

The hook part 142 includes a pair of hooks 144 having an end thereof wedge-shaped, and the hooks 144 are spaced apart in a predetermined distance each other.

The range of the distance spaced apart is wide enough for the fixing part 162 of the button 160 to be inserted therein, such that the fixing part 162 is fixed by the wedge of the hook 144 formed in the end of the hook 144.

Preferably, the hook 144 is made of elastic material. Thus, as shown in FIG. 7, the fixing part 162 of the button 160 is inserted between the both hooks 144 and fixed by the elasticity of the hook part 144.

Thus, the button 160 is fixed to the control panel cover 140 by the hook part 142, and the projecting part 166 is exposed through the hole 152 of the transparent window 150 to be supported by the elastic rib 164, so that the user may push the projecting part 166. Hence, the elastic rib 164 pushed by the user is elastically moving enough to push the switch (not shown) provided in rear.

Also, since the elastic rib 164 supports the projecting part 166, the projecting part 166 is moving backwardly according to the user's pushing of the projecting part 166 and presses the switch (not show) of the PCB (not shown). If the user's pushing is removed, the elastic rib 164 elastically restitutes to its original portion.

Thus, since the projecting part 166 of the button 160 which may be pushed by the user is provided in both opposite sides of the display window 132 and is not far from the portion where a screen is displayed, the user can operate the control panel 30 without turning away his/her eyes to see the display. Thereby, the control panel assembly according to the present invention has an advantageous effect that user convenience may be enhanced by the direct structure for the user's operation.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A control panel assembly for a laundry machine which has a control panel cover for defining an exterior thereof, a PCB having various electric sub-assemblies mounted thereon and a display part;
wherein the display part is a transparent window having at least one hole formed thereon and a button is provided trough the hole of the transparent window for allowing a user to operate outside.

2. The control panel assembly for a laundry machine of claim 1, wherein the button comprises:
an elastic rib having elasticity; and
a projecting part provided in a first end of the elastic rib, the projecting part projected outside through the hole of the transparent window.

3. The control panel assembly for a laundry machine of claim 2, wherein the button further comprises a fixing part provided in a second end of the elastic rib for fixing the button to the control panel.

4. The control panel assembly for a laundry machine of claim 3, wherein a hook part is provided in the control panel cover for fixing the fixing part of the button.

5. The control panel assembly for a laundry machine of claim 3, wherein a hook part is provided in a rear surface of the transparent window for securing the fixing part of the button.

6. The control panel assembly for a laundry machine of claim 4, wherein a pair of hooks is spaced apart in a predetermined distance each other and the fixing part of the button is inserted between the pair of hooks.

7. The control panel assembly for a laundry machine of claim 5, wherein a pair of hooks is spaced apart in a predetermined distance each other and the fixing part is inserted between the pair of hooks.

8. The control panel assembly for a laundry machine of claim 4, wherein a cut part is formed in a portion of the elastic rib of the button for allowing the elastic rib bent smoothly.

9. The control panel assembly for a laundry machine of claim 8, wherein the cut part is formed in a portion of the elastic rib toward the fixing part.
